(19) United States
(12) Patent Application Publication
(10) Pub. No.: US 2023/0147211 A1
(43) Pub. Date: May 11, 2023

(54) System and method for online shopping using dynamic linking information

(71) Applicant: Signature Athletics, Inc., Tampa, FL (US)

(72) Inventors: Daniel Soviero, Tampa, FL (US); Andrew Gilliland, Tampa, FL (US)

(21) Appl. No.: 17/454,076

(22) Filed: Nov. 9, 2021

(51) Int. Cl. G06Q 30/06; G06F 16/2457

(52) U.S. Cl. CPC G06Q 30/0631; G06Q 30/0627; G06Q 30/0643; G06F 16/2457

(57) ABSTRACT

A method for online shopping using a dynamic linking code (DLC) is provided. The method comprises displaying information associated with at least one item; obtaining a selection of the at least one item by the user; obtaining input information to virtually manipulate the selection of the at least one item; generating the DLC associated with the selected at least one item, the DLC pointing to at least one of: a first storage location of the database to store the status information indicative of a status of manufacturing of the at least one item; and a second storage location of the database comprising secondary information for recommending one or more other items to the user, based on the at least one item; and displaying output information associated with at least one of the status information or the promotional information, based on a delivery rule of the at least one item.

### TECHNOLOGICAL FIELD

This present disclosure relates to online shopping, and more particularly, to a system and a method for generating a print-ready image file as part of a custom online shopping portal, tracking the resulting item, and recommending similar items, using dynamic linking information.

### BACKGROUND

Conventionally, online site servers (also referred to as “servers”) have been used for connecting customers of one or more items such as shoes, clothing, home décor, and the like, to manufacturers of these one or more items. The servers provide an online platform to the customers/users to search for items the customers want, select items, customize the items, and issue an order to deliver/ship the customized items at locations desired by the customers. Associated with ordering, the server provides information and images associated with customization of the items ordered by the customers to the manufacturers. The manufacturers review customization information and then manufacture the items as per the customization information. After manufacturing the items, the items are shipped to desired locations of the customers.

Combining the items with chosen customizations has required the use of humans, which is time-consuming and costly. Further, tracking the status of the resulting item ordered by the user is challenging.

Further, recommending other items related to the one or more items ordered by the customers is advantageous for not only the manufacturers but also for the customers. Recommendations help the customer to find all the related items and associated information, which may help the customer to buy at least one of the recommended items from the same manufacturer.

Accordingly, there is a need of a system that enables the servers to provide managers of the portal with improved tracking information associated with manufacturing of customized items and provide manufacturers with production-ready images. Further, it would be advantageous to have the benefits of the recommendation systems also provided within such a system.

### SUMMARY

It is one of the objectives of the present disclosure to make customization, also referred to as “manipulation”, of one or more items, ordered by customers, completely automatic. During manufacturing, the resulting item is tracked through the process of manufacturing, allowing for tracking of the performance of each stage of manufacturing.

The described method, a system, and computer-programmable product allow a user, via an online order for at least one item, to manipulate the item, place an order, the status of the item tracked via a tracking code and database, the code later pointing the user to related, recommended items. To issue the online order, an online site server, also referred as “server” is provided. The server displays information associated with a plurality of items on a graphical user interface (GUI) which is accessed by the user by using the user device. The server obtains the information associated with the plurality of items from a database that stores the information associated with the plurality of items.

Within the GUI, the user may select at least one item to purchase from the plurality of items. After selecting an item, if the user wants to customize the item, the server provides an online item customization GUI, where the user may customize or manipulate the item virtually using the user device.

After finalizing the customization, a dynamic linking code associated with the item is generated. The dynamic linking code may take the form of a quick response (QR) code or a barcode. The dynamic linking code is configured to point to at least one of a first memory location of the database, where status information associated with completion of a stage of manufacturing the item is updated; or a second memory location of the database comprising promotional information for recommending one or more other items to the user, based on at least one item. The dynamic linking code can also include an association with manufacturing information. For example, cutting paths for fabric, color of thread and number of stitches for sewing, stitch location, and so forth.

Based on the customization input associated with the item selected by the user, a digital image file is generated. The digital image file is transmitted to a remote user device. The remote user device may be associated with a manufacturer responsible for manufacturing at least one item using the digital image file and delivering at least one item after completion of the manufacturing stage. Further, based on a delivery rule associated with the item, the server is configured to display an output information on the user device. The output information is associated with at least one of the status information of the item or secondary information also referred to as “promotional information”. The status information of the item provides status of completion of one or more manufacturing stages of the item being manufactured, whereas the promotional information comprises recommendation of one or more other items related to the item purchased by the user.

### BRIEF DESCRIPTION OF THE DRAWINGS

Having described example embodiments of the invention in general terms, reference will now be made to the accompanying drawings, which are not necessarily drawn to scale, and wherein:

FIG. 1 illustrates a block diagram of a network environment of a system for online shopping, in accordance with an example embodiment;

FIG. 2 illustrates a block diagram of the system for online shopping, in accordance with an example embodiment;

FIG. 3 illustrates an exemplary online item customization graphic user interface (GUI) for customizing a plurality of jerseys, in accordance with some embodiments;

FIG. 4A illustrates usage of a dynamic linking code (DLC), in accordance with some embodiments;

FIG. 4B illustrates DLC printed on a tag attached to a jersey, in accordance with an example embodiment;

FIG. 5A illustrates an example of a status updates GUI displaying status information, in accordance with some embodiment;

FIG. 5B illustrates an exemplary status updates GUI displaying a delivery rule, in accordance with some embodiment;

FIG. 6 illustrates a first URL and a second URL dynamically linked to the DLC based on the delivery criterion, in accordance with some embodiments; and

FIG. 7 illustrates a flow chart of a method for online shopping, in accordance with some embodiments.

### DETAILED DESCRIPTION

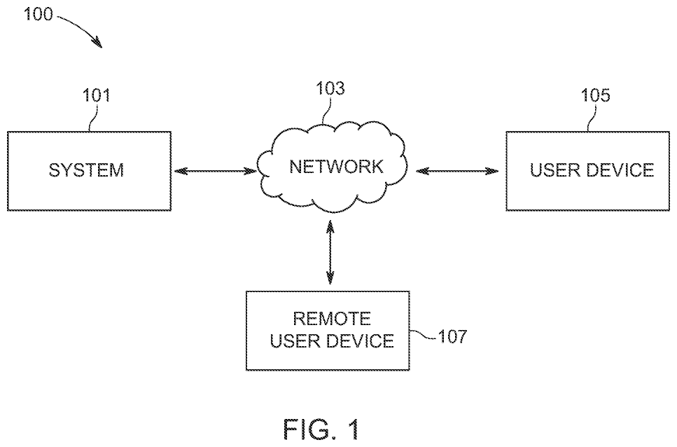

FIG. 1 illustrates a schematic diagram of a network environment 100 of a system 101 for online shopping, in accordance with an example embodiment. The system 101 may be communicatively coupled to a user device 105 and a remote user device 107 via a network 103. The components described in the network environment 100 may be further broken down into more than one component and/or combined together in any suitable arrangement.

In an example embodiment, the system 101 is arranged in one or more ways. For example, the system 101 may be embodied as a cloud-based service or a cloud-based platform. The system 101 may be communicatively coupled to the components shown in FIG. 1 to carry out the desired operations and wherever required modifications may be possible within the scope of the present disclosure. Alternatively, the system 101 may be implemented using a server and a database.

In certain example embodiments, the user device 105 and the remote user device 107 are any user accessible device such as a mobile phone, a smartphone, a portable computer, and the like. In an example embodiment, a user of the remote user device 107 may be a manufacturer or a vendor who manufactures items sold via the online site, hosted on a server. In an example embodiment, a user of the user device 105 may comprise a coach of a sports team, where the coach may issue an online order for manufacturing of a plurality of sportswear, such as jerseys, shorts, shoes, or balls for a plurality of team members. Accordingly, while issuing the online order, the coach may specify sizes of each sportswear corresponding to each team member of the plurality of team members. The coach may further customize sportswear for each team member. For example, the coach may specify a number, such as a uniform number to be printed on a jersey of each team member of the plurality of team members and artwork to be printed on a plurality of jerseys corresponding to the plurality of team members.

The user device 105 and the remote user device 107 may comprise a processor, a memory, and a communication interface. The processor, the memory and the communication interface may be communicatively coupled to each other. In example embodiments, the user device 105 and the remote user device 107 may comprise a processing module such as a central processing unit (CPU), storage module such as on-board read-only memory (ROM). The user device 105 and the remote user device 107 may be configured to execute and run mobile applications such as a messaging application, a browser application, a navigation application, or similar.

The network 103 may be wired, wireless, or any combination of wired and wireless communication networks, such as cellular, Wi-Fi, internet, local area networks, or the like. In one embodiment, the network 103 may include one or more networks such as a data network or a wireless network.

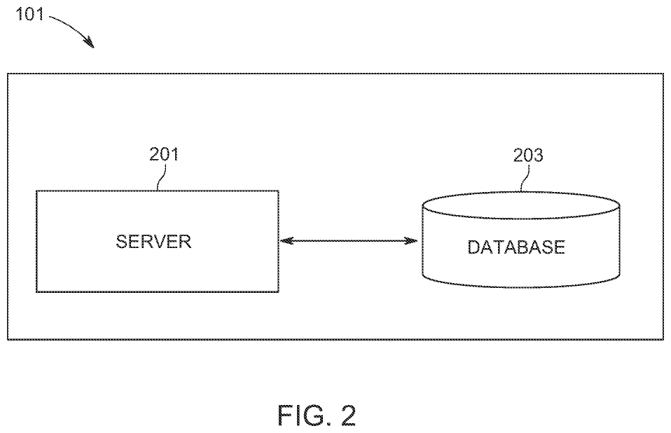

FIG. 2 illustrates a block diagram of the system 101 for online shopping, in accordance with an example embodiment. FIG. 2 is described below in conjunction with FIG. 1. The system 101 comprises a server 201 and a database 203. The database 203 is configured to store the information associated with the plurality of items, where the plurality of items comprises garments, such as jerseys, pants, footwear, gloves, hats, and headgear. The information may comprise at least one or combination of sizes, colors, prices, and reviews, associated with the plurality of the items. In one or more example embodiments, the database 203 is updated periodically to store updated information associated with the plurality of items and add information associated with one or more new items to the database 203.

The database 203 is coupled with the server 201. In some embodiments, the database 203 is at a remote location and the database is coupled with the server 201 by the network 103 (see FIG. 1). In an example embodiment, the server 201 may comprise memory configured to store computer executable instruction, a processing module, and a communication module. For example, the processing module may comprise at least one processor configured to process requests or information received from the user device 105 and the remote user device 107. For instance, based on request by a user from the user device 105, the processing module may fetch information associated with a plurality of items from the database 203 and display the same to a user on the user device 105 by using an item displaying GUI.

Further, the server 201 is configured to obtain from the user device 105 (see FIG. 1), a selection of at least one item from the plurality of items displayed to the user on the item displaying GUI. After selecting at least one item, the server 201 allows the user to virtually manipulate or customize the selected at least one item. To that end, the server 201 is configured to obtain input information from the user device 105 and virtually manipulate the item based on the input information, also referred to as “customization information.” Further, the server 201 may display the item while it is being manipulated, enabling the user to update or reject the manipulation if required.

In some embodiments, the server 201 may be configured to use an online item manipulation GUI, where the user may customize the selected at least one item. The item manipulation GUI may be a webpage displayed to the user on the user device 105. To manipulate the item, the user may access the item manipulation GUI to input the customization information such as one or more artwork that the user wants to be printed on the item, one or more custom fields comprising information such as names or numbers that the user wants to be printed on the item, and the likes.

In an example embodiment, the item manipulation GUI may provide one or more tools to the user to manipulate the item. For example, the item manipulation GUI may suggest one or more artworks to the user to be printed on the item. The one or more artworks suggested by the item manipulation GUI may be fetched by the server 201 from the database 203. Thus, based on the input information the selected at least on item is virtually manipulated.

In an example embodiment, some information to be printed on the item may be predefined, where the predefined information may be provided to an operator of the server 201. The operator may be a manufacturer or a vendor of sportswear. In another embodiment, the operator of the server 201 may be in direct communication with one or more manufacturers of the sportswear. For example, a coach of a sports team may provide name of a team and one or more artwork to be printed on jerseys of team members to the operator of the server and obtain a unique link, such as a unique resource locator (URL) that each team member may use to access the server 201 and customize the jersey as required. For instance, team members may provide their unique uniform numbers to be printed on their jerseys, they may select sizes.

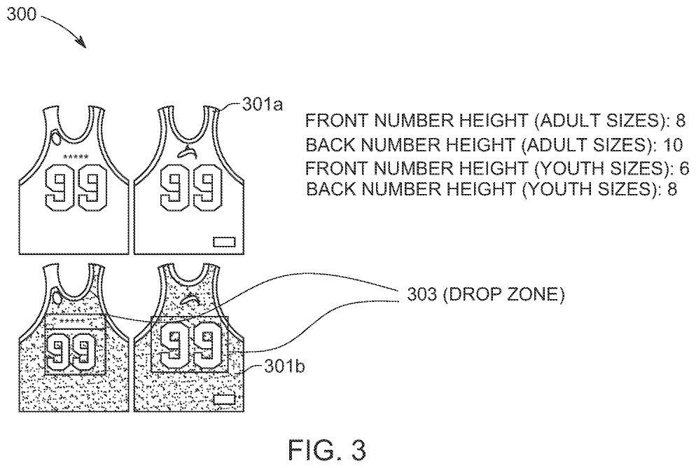

FIG. 3 illustrates an exemplary online item customization graphic user interface 300 for customizing a plurality of jerseys 301a and 301b, in accordance with some embodiments. FIG. 3 is described below in conjunction with FIG. 2. Assume that the user may have already selected a type of jersey from the item displaying GUI. The user may have decided to order a plurality of jerseys 301a and 301b of the selected type of jersey, where the plurality of jerseys 301a and 301b is of different sizes. For example, the plurality of jerseys comprises four jerseys of adult size (301a) and three jerseys of youth size (301b). Further, the user wants to customize the plurality of jerseys 301a and 301b. Accordingly, the server 201 displays the online item customization GUI 300, where the user, via the user device 105, may customize the plurality of jerseys 301a and 301b.

For example, in the FIG. 3, the user manipulates the plurality of jerseys 301a and 301b by inputting a number 99 in a specific area known as a drop zone 303 at the back and front of each jersey of plurality of jerseys 301a and 301b. The drop zone 303 is a predefined area on each item, for example as on jersey 301a and jersey 301b, of the plurality of items stored in the database 203, where the user can input custom information such as names, numbers, and the like. In some embodiments, the user may add one or more artworks in the drop zone 303. Further, a location of the drop zone 303 may vary based on each item of the plurality of items. For example, the location of the drop zone 303 may depend on a type of item ordered by the users. For instance, drop zones defined for a sports jersey, such as front side and back side of the jersey, may be different from a drop zone defined for shorts, or sports shoes. In another embodiment, the drop zone 303 may be defined at different locations by the user. For example, the coach of the sports team may define different drop zones for different items such as the jersey and the shorts to be worn by the sports team.

The user may further customize plurality of jerseys 301a and 301b such that the four adult size jerseys 301a are of white color and the three youth size jerseys 301b are of grey color as illustrated in FIG. 3. Further, the user can customize the font size of the inputted number. For example, height of the number to be printed on the back side of the four adult size jerseys 301a is selected as 10 and that on the front side of the four adult size jerseys 301a is selected as 8. Similarly, height of the number to be printed on the back side of the three youth size jerseys 301b is selected as 6 and that on the front side of the three youth size jerseys 301b is selected as 8.

Referring back to FIG. 2, after finalizing the manipulation of the items, the user may issue an online order on the server 201 to purchase the item. Upon issuance of the online order, manufacturing of item and customizing the item as per the input information begins. Further, the data associated with the item is stored in the database 203, which may be used to record or store status information of manufacturing the item.

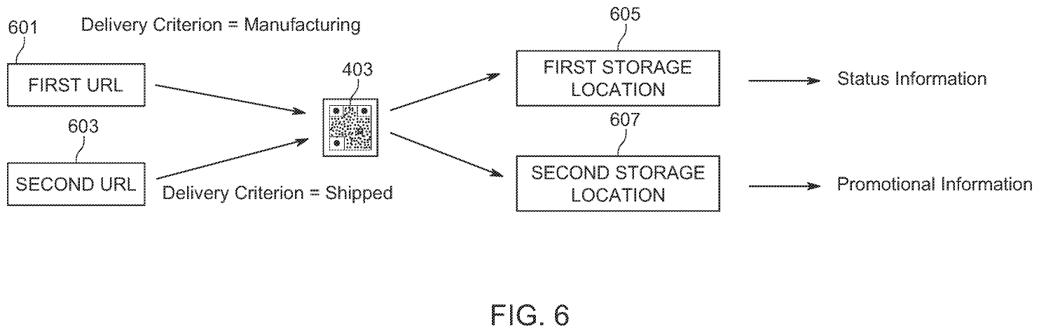

Further, a dynamic linking code (DLC) associated with the item is generated. The DLC includes a quick response (QR) code or a barcode. The DLC is initially configured to point to at least one of a first storage location of the database 203 to store status information indicative of a status of completion of a stage of manufacturing of the item. Following delivery of the item to the customer, the DLC will be altered to point to a second storage location of the database 203 comprising promotional information, or secondary information, for recommending one or more other items to the user, based on the item that was ordered. To that end, the DLC is dynamically linked to a unique resource locator (URL), either a first URL or a second URL, where the first URL points to the first storage location of the database 203 and the second URL points to the second storage location of the database 203. More details regarding dynamic linking of the DLC to the first URL and the second URL is provided later with reference to FIG. 6.

The server 201 may be further configured to store, at the first storage location of the database 203, information associated with the selected at least one item. The information can include a unique item code associated with the item, names of the plurality of manufacturing stages involved in manufacturing the item, and a delivery rule, which is also sometimes referred to as “delivery criterion”, indicating whether the item is shipped to the user or not. In some embodiments, the input information associated with the manipulation of the item may be stored at the first storage location.

The server 201 is further configured to generate a digital image file based on the DLC and the input information associated with the manipulation of the selected at least one item, where the DLC is included as a graphic within the digital image file. The digital image file is transmitted to the remote user device 107, where the remote user device 107 is associated with at least one manufacturer of the item. The remote user device 107 uses the digital image file to manufacture at least one item. The remote user device 107 may be coupled with one or more machines that may be used for manufacturing the item. The manufacturing of the items may include a plurality of stages that vary based on a type of the item. For example, for manufacturing a jersey the manufacturing stages may include a printing stage, a cutting stage, and a sewing stage. Further, the one or more machines may include a dye sublimation printer that uses heat to transfer dye onto materials such as a plastic, card, paper, or fabric to print input information. Input information can include artwork, and/or custom field information including numbers and team names.

The remote user device 107 may provide the digital image file to the one or more machines, where the one or more machines are configured to decode the digital image file and manufacture the item as per the input information encoded in the digital image file. Further, based on the digital image file, the one or more machines print the DLC on a tag that may be attached to the at least on item during the manufacturing process.

In some embodiment, the DLC may be printed anywhere on the item, for example, in a drop zone of the item. The drop zone is the predefined specific area, where the DLC associated with the item and information associated with custom fields such as names, numbers, and similar, as illustrated in FIG. 3, are printed. The drop zone is predefined for each item of the plurality of items in the database 203. A location of the drop zone may vary based on the item. In some embodiments, location information associated with the drop zone to print the DLC on the item is also encoded in the digital image file. Therefore, based on the digital image file, the one or more machines print the DLC associated with the item on the predefined drop zone for the item.

The manufacturing process of the item may include a plurality of stages, where the stages vary based on a type of the item. For instance, the number of stages for manufacturing a pair of shoes are different from that of the number of stages for manufacturing a t-shirt. In an example embodiment, the manufacturing process may comprise a single stage. Based on completion of a stage of the manufacturing process, the manufacturers may update status information associated with the manufacturing of the item. Further, on completion of all the stages of manufacturing an item, the item may be delivered to the user. Accordingly, the manufacturers may further update information associated with the delivery rule of the item at the first storage location of the database 203, where the delivery rule is indicative of at least one of: the item is shipped or the item is at the manufacturing stage.

The status information and the delivery rule of the at least on item is obtained by the server 201, where the server 201 is configured to display output information based on the delivery rule of the at least on item.

To update the status information and the delivery rule, the at least one manufacturer uses the remote user device 107 to read or scan the DLC associated with the item. The DLC is initially configured to point at the first storage location of the database 203. On scanning the DLC using the remote user device 107, the server 201 is configured to display a graphical user interface on the remote user device 107. The graphical user interface is accessed by the at least one manufacturer by using the remote user device to update the status information and the delivery rule associated with the item at the first storage location of the database 203. For example, the at least one manufacturer may update the status of completion of each stage of manufacturing across the unique item code associated with the item and under the name of the corresponding stages of manufacturing involved to manufacture the item as per the input information associated with the at least on item. Further, the at least one manufacturer updates the delivery rule at the first storage location of the database 203.

The server 201 obtains the status information and the delivery rule updated by the at least one manufacturer at the first storage location of the database 203. To that end, the server 201 may periodically check the first storage location. In an example embodiment, a flag is generated when the first storage location of the database 203 is updated, and then based on the generated flag, the server 201 obtains the updated status information and the updated delivery rule from the first storage location of the database 203.

The server 201 is configured to update the output information based on the delivery rule. For example, when the obtained delivery rule is indicative of the item is in the manufacturing stage the server 201 displays, on a status updates GUI, the status information indicative of the completion of one or more stages associated with the manufacturing of the item. The user, likely the third-party who manages the website through which the item was ordered, may view the status information using the user device 105 by accessing the status updates GUI hosted by the server 201 and track the manufacturing status of the item that the user has ordered. To that end, the server 201 may receive a request, from the user device 105, to view the status information associated with the item. In response, the server 201 may obtain the delivery rule associated with the item from the first storage location of the database 203. Based on determining that the delivery rule indicates that the item is in the manufacturing stage, the server 201 displays output information associated with the status information of the item in the manufacturing stage on the user device 105.

On the other hand, when the obtained delivery rule indicates that the item was shipped, the DLC is updated to point to the second storage location of the database 203, where the second storage location of the database 203 comprises the promotional information. To that end, the URL, to which the DLC initially configured to point at i.e., the first storage location, is modified to access a recommendation GUI that obtains one or more other items associated with the item purchased by the user from the second storage location of the database 203.

To access the recommendation GUI, the user may scan or read the DLC printed on a tag attached to the item by using the user device 105. After scanning the DLC, the user device 105 displays the recommendation GUI, where the one or more other items associated with the item are recommended. In an example embodiment, the server 201 may be configured to display the one or more other items that are manufactured by the manufacturer of the item.

To that end, the server 201 may receive a request, from the user device 105, to view the promotional information associated with the item, where the request is received when the dynamic linking code is scanned by the user device 105. In response, the server 201 may obtain the delivery rule associated with the item from the first storage location of the database 203. Based on determining that the delivery rule indicates that the item is shipped, the server 201 displays output information associated with the promotional information on the user device 105.

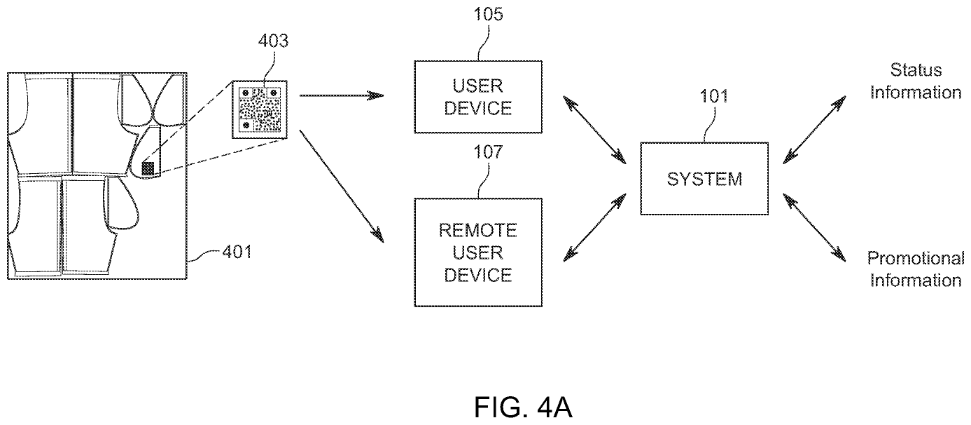

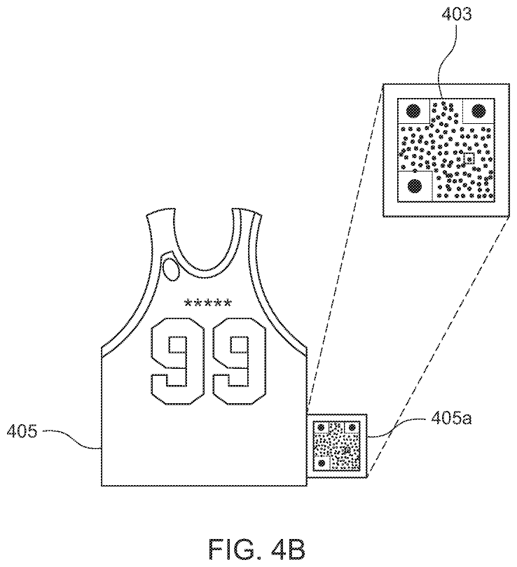

FIG. 4A illustrates usage of a DLC 403, in accordance with some embodiments. FIG. 4A is described below in conjunction with FIG. 1 and FIG. 2. FIG. 4A illustrates the DLC 403 printed on a piece of a fabric which is to be sewed with other pieces of the fabric to manufacture a garment 401 and customize it as per the input information provided by the user.

During manufacturing of the garment 401, at least one manufacturer uses a digital image file associated with the garment 401 to manufacture the garment 401 as per customization information, inputted by the user, encoded in the digital image file. The digital image file includes the DLC 403, associated with the garment 401, as a graphic. The DLC 403 is printed at a specific location on the garment 401.

In an example embodiment, the DLC 403 may be printed on a tag to be attached to the garment ordered by the user. FIG. 4B illustrates the DLC 403 printed on a tag 405a attached to a jersey 405, in accordance with some embodiments. In FIG. 4B, the jersey 405 is ordered and customized by the user virtually on the server 201. The tag 405a may be attached to the jersey 405 during manufacturing of the jersey 405.

Referring to FIG. 4A, the manufacturing of the garment 401 comprises a plurality of stages for example, a printing stage, a cutting stage, and a sewing stage. The plurality of stages for manufacturing a garment 401 such as the jersey 405 (see FIG. 4B) may be predefined and stored at the first storage location in the database 203.

For example, during manufacturing of the garment 401, a first stage of the manufacturing corresponds to the printing stage, where one or more machines are provided with the digital image file associated with the garment 401, and where the one or more machines print the customization information on a piece of fabric, to be manufactured into the garment 401, at the drop zone predefined for the garment 401. Further, the DLC 403 is also printed at a specific location on the piece of fabric associated with the garment 401. The location for printing the DLC 403 on the garment 401 may be predefined. In an example embodiment, the DLC 403 may be printed at the drop zone along with the customization information. For example, the customization information to be printed on the piece of fabric at the drop zone specified for the garment 401 may comprise one or more artworks then the DLC 403 may be printed at the drop zone on the piece of fabric along with the customization information such that the aesthetic value of the customization information does not degrade because of the DLC 403. In an example embodiment, the DLC 403 may be printed anywhere on the garment 401. In an example embodiment, the specific location for printing the DLC 403 on the garment 401 may be defined in the digital image file.

In an example embodiment, the DLC 403 printed on the piece of fabric is used for automating subsequent manufacturing processes such as the cutting stage and the sewing stage. For example, the DLC 403 printed on the piece of fabric may comprise information associated with cutting paths to be used by cutting machines such as laser cutting machine to cut the fabric 401 into a specific size provided by the user in the customization information. Thus, the laser cutting machine obtains cutting path by reading the DLC 403 and automatically cuts the fabric in the specific shape. The DLC 403 may further comprises information associated with sewing of the fabric such as color of threads to be used in sewing the fabric, number of stiches to be used for sewing the fabric, and the likes. For example, the sewing machine on reading the DLC 403 may automatically use a thread of a specific color and a specific number of stiches for sewing the fabric, where the color of threads and the number of stiches to be used for sewing by the sewing machine are encoded in the DLC 403. In this way, the digital image file comprising the DLC 403 as a graphic automates the manufacturing process.

In some embodiments, the customization information is printed on a first piece of fabric i.e., the jersey 405 (see in FIG. 4B) and the DLC 403 on a second piece of fabric depending upon the digital image file associated with the jersey 405. The second piece of fabric is smaller than the first piece of fabric and is attached as the tag 405a to the first piece of fabric at the final stage, such as sewing, during manufacturing the jersey 405 with the tag 405a as shown in jersey 405 of the FIG. 4B.

Still referring to FIG. 4A, on completion of the first stage, the manufacturer may use a reader device coupled with the remote user device 107 to scan the DLC 403 printed on the piece of fabric associated with the garment 401, where the DLC 403 is initially configured to point at the first storage location of the database 203. Thus, by scanning the DLC 403, the manufacturer can access the first storage location, where the manufacturer updates status information associated with completion of the first stage of manufacturing the garment 401. Further, the manufacturer updates the delivery rule of the garment 401 to indicate that the garment 401 is in the manufacturing stage. The server 201 may obtain the delivery rule of the garment 401 which indicates that the garment 401 is in the manufacturing stage. Therefore, the server 101 obtains the status information of manufacturing the garment 401 and display the status information on the status updates GUI. Further, the server 201 may be configured to display the delivery rule on the status updates GUI. The user can view the status information and the delivery rule on the status updates GUI by using the user device 105 to track the status of the manufacturing of the garment 401.

Similarly, in the second stage that may involve cutting the printed piece of fabric associated with the garment 401 into a size encoded in the digital image file. On completing the second stage, the manufacturer further scans the DLC 403 printed on the piece of fabric associated with the garment 401 using the reader device coupled with the remote user device 107 to access the first storage location, where the manufacturer updates status information associated with completion of the second stage of manufacturing the garment 401. Further, the manufacturer updates the delivery rule of the garment 401 to indicate that the garment 401 is in the manufacturing stage. The server 201 may obtain the delivery rule of the garment 401 which indicates that the garment 401 is in the manufacturing stage. Therefore, the server 201 obtains the status information and display the status information on the status updates GUI. Further, the server 201 may be configured to display the updated delivery rule on the status updates GUI. The user can view the updated status information and the updated delivery rule on the status updates GUI by using the user device 105 to track the status of the manufacturing of the garment 401.

Similarly, the manufacturer updates the status information and the delivery rule on completion of the final stage of manufacturing the garment 401 that involves sewing the printed and cut piece of fabric into the garment 401 wearable by the user. On completing the third stage, the manufacturer may further scan the DLC 403 using the reader device coupled with the remote user device 107 to access the first storage location, where the manufacturer updates status information associated with completion of the third stage of manufacturing the garment 401. After completion of all the stages of manufacturing the garment 401, the garment 401 may be shipped to the user at a location provided by the user while issuing the online order. Accordingly, the manufacturer updates the delivery rule of the garment 401 to indicate that the garment 401 is shipped. The server 201 may obtain the delivery rule of the garment 401 which indicates that the garment 401 is shipped. Accordingly, the server 201 obtains the status information indicating a completion of the final stage of manufacturing and display the updated status information on the status updates GUI. Further, the server 201 may be configured to display the updated delivery rule on the status updates GUI. The user can view the updated status information and the updated delivery rule on the status updates GUI by using the user device 105 to track the status of the manufacturing of the jersey 401.

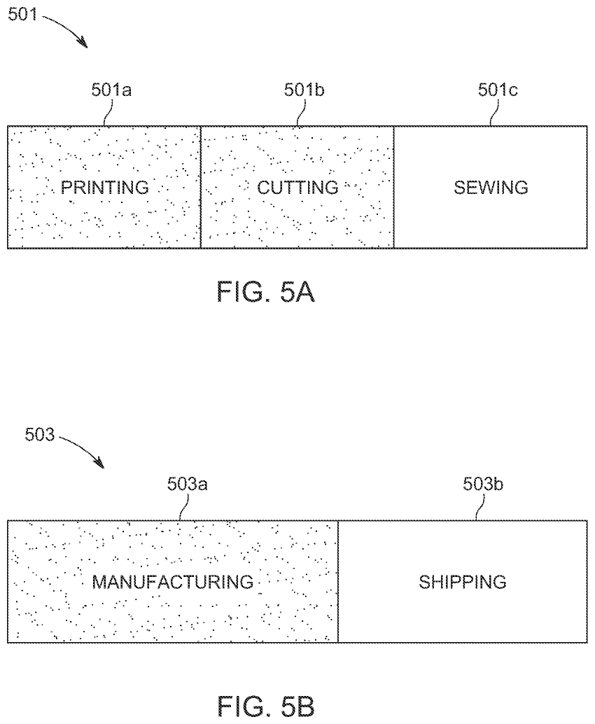

FIG. 5A illustrates an exemplary status updates GUI displaying status information 501, in accordance with some embodiment. FIG. 5B illustrates an exemplary status updates GUI displaying delivery rule 503, in accordance with some embodiment. FIG. 5A and FIG. 5B are described below in conjunction with FIG. 4A. The plurality of stages for manufacturing the garment 401 includes the printing stage 501a, the cutting stage 501b, and the sewing stage 501c. The plurality of stages of manufacturing the garment 401 may be predefined and stored in the database 203. Based on the status information associated with the manufacturing of the garment 401, the user can infer that the printing stage 501a and the cutting stage 501b of the garment 401 is completed and only the sewing stage 501c is left. The user may verify the status information of the manufacturing from the delivery rule 503 indicating that the garment 401 is in the manufacturing stage 503a.

In an example embodiment, the status information 501 and the delivery rule 503 may be automatically updated by the remote user device 107 based on completion of each stage of the manufacturing.

Referring back to FIG. 4A, when the manufacturer updates the first storage location of the database 203 with the delivery rule that indicates that the garment 401 is shipped, the server 201 is configured to update the DLC 403 to point at the second storage location of the database 203. To that end, the URL encoded by the DLC 403 is modified to locate to the second storage location of the database 203. The user on receiving the garment 401 may scan the updated DLC 403 using the user device 105, where the updated DLC 403 directs the user device 105 to the recommendation GUI hosted by the server 201. The recommendation GUI comprises promotional information such as recommended one or more other items associated with the garment 401.

FIG. 6 illustrates a first URL 601 and a second URL 603 dynamically linked to the DLC 403 based on the delivery rule 503. FIG. 6 is described below in conjunction with FIG. 4A, FIG. 5A, and FIG. 5B. When the delivery rule 503 indicates that the garment 401 is in the manufacturing stage 503a, the DLC 403 is configured to encode the first URL 601. Therefore, when the DLC 403 is scanned by the reader device coupled with the remote user device 107, the remote user device 107 is directed to a first storage location 605 of the database 203, where the status information may be accessed by the remote user device 107. Alternatively, when the delivery rule 503 is updated by the manufacturer to indicate that the garment 401 is the shipping stage 503b, the first URL 601 pointed to by the DLC 403 is replaced with a second URL 603. Therefore, when the DLC 403 is scanned by the user device 105, the user device 105 is directed to a second storage location 607, storing the promotional information associated with the garment 401. In this way, the DLC 403 is updated to point at the second storage location 607 based on the delivery rule.

Thus, the server 201 is configured to dynamically determine content to be presented in response to a scan of the DLC (such as DLC 403) by either the user device 105 or the remote user device 107. Initially, the server 201 is configured to generate a unique DLC associated with the item selected by the user on the item displaying GUI, where the DLC is configured to encode a web site address or URL. The encoded URL is a network address of the database 203. Further, during manufacturing of the selected at least on item, the unique DLC associated with the item being manufactured is printed either directly on the item ordered by the user (see in FIG. 4A) or on a tag, such as the tag 405a (see in FIG. 4B), that may be attached to the item at a first or a final stage of manufacturing. Thus, the DLC is visually displayed in the real world to a user, where the user may be at least one of the manufacturers responsible for manufacturing the at least on item or the user who ordered the item.

In some embodiments, the server 201 is configured to establish rules for the content to be delivered in response to a scan of the DLC from the user device 105 and the remote user device 107. For example, the server 201 is configured to deliver different contents to different users based on a delivery rule of the item, on scanning the DLC. For example, the server 201 is configured to deliver the first storage location of the database 203 to update the status information when the DLC is scanned by the remote user device 107 during manufacturing, whereas the server 201 is configured to deliver the promotional information from the second storage location of the database 203 when the DLC is scanned by the user device 105.

In some embodiments, the server 201 may be configured to display promotional information content on scanning the DLC based on a type of the item purchased by the user of the user device 105. For example, the one or more other items included in the promotional information may be different when the item ordered by the user corresponds to a pair of shoes than when the item corresponds to clothing.

In some embodiments, when the DLC is scanned by a wireless device, such as the user device 105 or the remote user device 107 the wireless device 105, 107 transmits an indication of the DLC scanned by the wireless device 105, 107 to the server 201, where the scanning application decodes the DLC and then provide the URL encoded in the DLC and directs the wireless device thereto. The server 201 is configured to receive the indication of the DLC scanned by the wireless device 105, 107 and determine variables associated with the indication such as name of the item the DLC is associated with, the delivery rule of the item, and the type of the item. The server 201 then applies the established rules for the determined variables and delivers the content to the wireless device 105, 107 that is determined based on the rules.

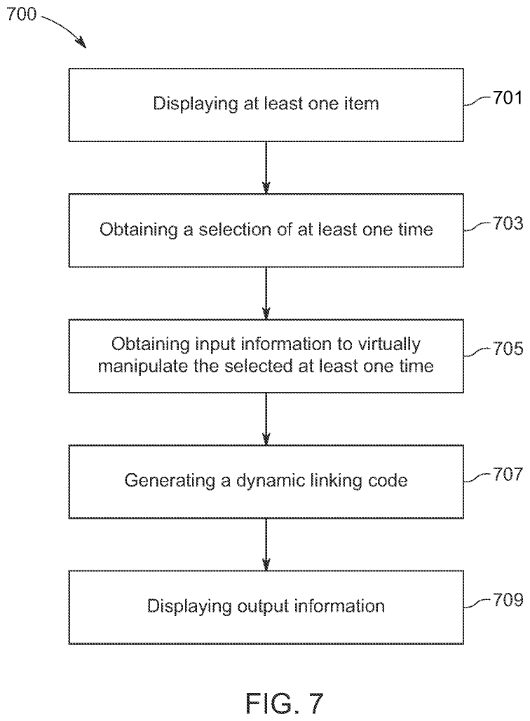

FIG. 7 illustrates a flowchart of a method 700 for online shopping, in accordance with some embodiments. FIG. 7 is described below in conjunction with FIG. 2. The method 700 may be executed by the server 201. At step 701, information associated with at least one item from a plurality of items is displayed on the user device 105 of the user. The information associated with the item is obtained by the server 201 from the database 203, where information associated with the plurality of items is stored. The information associated with the item may be displayed on the item displaying GUI hosted by the server 201. The information associated with at least one item from a plurality of items may displayed on the user device 105 by the server 201 in response to a request from the user, via the user device 105

At step 703, a selection of the item by the user is obtained by the server 201 via the user device 105. To that end, the user may select the at least on item from the item displaying GUI via the user device 105, such as by clicking, pointing, touching, and the like. On selecting the item, the user may be prompted to customize the selected at least one item. If the user chooses to customize the selected at least one item, the server 201 may direct the user device 105 to the online item customization GUI.

At step 705, input information, from the user device 105, for virtually manipulating the selected at least one item is obtained by the server 201, where the item is manipulated using the online item customization GUI. In an example embodiment, the online item customization GUI may receive from the user device 105, customization information such as one or more artwork that the user wants to be printed on the item, one or more custom fields comprising information such as names or numbers that the user wants to be printed on the item, and the likes. Further, the online item customization GUI allows the user to view the virtually customized at least one item in real-time.

The input information may include custom information such as names, numbers, and one or more artworks that the user wants to be printed on the item during manufacturing of the item.

At step 707, a dynamic linking code (DLC) is generated for the item, where the DLC is unique for the item. The DLC may be printed on the item during manufacturing of the item. The DLC may comprise at least one of a QR code, a bar code, or another symbol that encodes a URL to a specific network location. For example, the DLC may point to at least one of a first storage location of the database to store the status information indicative of a status of completion of a stage of manufacturing of the item ordered by the user or a second storage location of the database comprising promotional information for recommending one or more other items to the user, based on the item. In some embodiments, the DLC is scanned by the reader device coupled with the remote user device 107 to access the first storage location of the database 203 to update status information associated with the manufacturing of the item and the delivery rule. In some embodiments, the DLC is scanned by the user device 105 to obtain the promotional information recommending one or more other items associated with the item, where the one or more other items are obtained from the second storage location of the database 203.

In some embodiments, the DLC is used to automate at least some manufacturing stages of the plurality of manufacturing stages involved in manufacturing the item. For example, the DLC may be printed on the item at a first stage of manufacturing the item. The DLC printed on the item may comprise information that can automate at least some of the manufacturing stages of the item. For example, when the item corresponds to a pair of shoes, the DLC may be printed on a material such as leather, rubber, and the like used to manufacture the pair of shoes, where size of the material and type of the material to be used for manufacturing the pair of shoes is predefined. The DLC printed on the material is used to automate subsequent manufacturing stages such as cutting the material and sewing it to manufacture the pair of shoes of size, shape, and design provided by the user as customization information. For example, the DLC may comprise information associated with cutting paths to be used by cutting machines such as laser cutting machine to cut the material into a specific size and shape provided by the user in the customization information. Thus, the laser cutting machine obtains cutting path by reading the DLC and automatically cuts the material in the specific size and shape. The DLC may further comprises information associated with sewing of the material such as color and/or type of polyester to be used in sewing the material into the pair of shoes of specific size, number of stiches to be used for sewing the material, and the likes. For example, the sewing machine on reading the DLC may automatically use a specific type of a polyester and a specific color of the polyester for sewing the pair of shoes. Further, the sewing machine on reading the DLC may automatically use a specific number of stiches for sewing the material into the pair of shoes, where the color and type of the polyester and the number of stiches to be used for sewing are encoded in the DLC. In this way, the digital image file comprising the DLC automates the manufacturing process.

Finally, at step 709 output information associated with at least one of the status information or the promotional information is displayed on the user device 105, based on a delivery rule of the item. For example, the output information associated with at least one of the status information is displayed on the status updates GUI, where the status updates GUI is displayed on the user device 105 by the server 201 when the delivery rule indicates that the item is in the manufacturing stage. To that end, the server 201 may receive a request, from the user device 105, to view the status information associated with the item. In response, the server 201 may obtain the delivery rule associated with the item from the first storage location of the database 203. Based on determining that the delivery rule indicates that the item is in the manufacturing stage, the server 201 displays output information associated with the status information of the item in the manufacturing stage on the user device 105.

On the other hand, the output information associated with the promotional information is displayed on the recommendation GUI, where the recommendation GUI is displayed on the user device 105 by the server 201 when the delivery rule indicates that the item is shipped. To that end, the server 201 may receive a request, from the user device 105, to view the promotional information associated with the item, where the request is received when the dynamic linking code is scanned by the user device 105. In response, the server 201 may obtain the delivery rule associated with the item from the first storage location of the database 203. Based on determining that the delivery rule indicates that the item is shipped, the server 201 displays output information associated with the promotional information on the user device 105.

In this way, the DLC printed on the item may be used to guide customers to upsells, retailers and guide the manufacturers to manage inventory, third party logistics/warehouses, to inform shipping requirements, reverse logistics to manage returns, and the likes. Further, the DLC printed on the item is also used by the at least one manufacturer for updating status information associated with the manufacturing and/or delivery of the items. In some embodiments, the DLC printed on the item is used for automating at least some of the manufacturing processes.

What is claimed is:

1. A system comprising:
a database configured to store status information and information associated with a plurality of items;
a server linked to the database, the server comprising:
a memory configured to store computer-executable instructions; and
at least one processor configured to execute the stored computer-executable instructions to:
display, on a user device, the information associated with at least one item from the plurality of items;
obtain, from the user device, a selection of the at least one item by a user;
obtain input information, from the user device, to virtually manipulate the selection of the at least one item;
generate a dynamic linking code associated with the selected at least one item, the dynamic linking code configured to point to at least one of:
a first storage location of the database to store the status information indicative of a status of completion of a manufacturing stage of the at least one item; and
a second storage location of the database comprising secondary information for recommending one or more other items to the user, based on the at least one item; and
display, on the user device, output information associated with at least one of the status information or the secondary information, based on a delivery rule of the at least one item, the delivery rule specifying whether the at least one item has completed manufacturing and been shipped to the user.

2. The system of claim 1, wherein the at least one processor is further configured to:
generate a digital image file based on the input information and the dynamic linking code and including the dynamic linking code as a graphic within the digital image file; and
transmit the digital image file to a remote user device, wherein the remote user device is associated with at least one manufacturer of the at least one item.

3. The system of claim 2, wherein:
the dynamic linking code is scanned by a reader device coupled with the remote user device to update the first storage location of the database with the status information of the at least one item in the manufacturing stage and the delivery rule of the at least one item, and wherein the dynamic linking code is pointing to the first storage location.

4. The system of claim 3, wherein:
on scanning the dynamic linking code by the reader device coupled with the remote user device, the at least one processor is further configured to display, on the remote user device, a graphical user interface, and wherein the graphical user interface is accessed by the at least one manufacturer by using the remote user device to update the first storage location of the database.

5. The system of claim 1, wherein the dynamic linking code is printed on the at least one item.

6. The system of claim 1, wherein the at least one processor is further configured to:
obtain the delivery rule of the at least one item; and
based on determining that the delivery rule indicates that the at least one item is shipped, update the dynamic linking code to point at the second storage location of the database.

7. The system of claim 1, wherein the at least one processor is configured to:
receive a request, from the user device, to view the status information associated with the at least one item;
obtain the delivery rule associated with the at least one item from the first storage location of the database;
based on determining that the delivery rule indicates that the at least one item is in the manufacturing stage, display output information associated with the status information of the at least one item in the manufacturing stage on the user device.

8. The system of claim 1, wherein the at least one processor is configured to:
receive a request, from the user device, to view the secondary information associated with the at least one item, wherein the request is received when the dynamic linking code is scanned by the user device;
obtain the delivery rule associated with the at least one item from the first storage location of the database;
based on determining that the delivery rule indicates that the at least one item is shipped, display output information associated with the secondary information on the user device.

9. The system of claim 1, wherein the dynamic linking code comprises at least one of a quick response (QR) code or a barcode.

10. The system of claim 1, wherein the input information to virtually manipulate the selected at least one item comprises at least one of:
one or more artworks to be printed on the selected at least one item, or
customer specific information to be printed on the selected at least one item.

11. A method comprising:
displaying, on a user device, information associated with at least one item from a plurality of items;
obtaining, from the user device, a selection of the at least one item by a user;
obtaining input information, from the user device, to virtually manipulate the selection of the at least one item;
generating a dynamic linking code associated with the selected at least one item, the dynamic linking code pointing to at least one of:
a first storage location of a database to store status information indicative of a status of completion of a manufacturing stage of the at least one item; and
a second storage location of the database comprising secondary information for recommending one or more other items to the user, based on the at least one item; and
displaying, on the user device, output information associated with at least one of the status information or the secondary information, based on a delivery rule of the at least one item, the delivery rule specifying whether the at least one item has completed manufacturing and been shipped to the user.

12. The method of claim 11, wherein the method further comprises:
generating a digital image file based on the input information and the dynamic linking code and including the dynamic linking code as a graphic within the digital image file; and
transmitting the digital image file to a remote user device, wherein the remote user device is associated with at least one manufacturer of the at least one item.

13. The method of claim 12, wherein:
the dynamic linking code is scanned by a reader device coupled with the remote user device to update the first storage location of the database with the status information of the at least one item in the manufacturing stage and the delivery rule of the at least one item, and wherein the dynamic linking code is pointing to the first storage location.

14. The method of claim 13, wherein:
the method further comprises displaying a user interface on scanning the dynamic linking code by the remote user device, and wherein the user interface is accessed by the at least one manufacturer by using the remote user device to update the first storage location of the database.

15. The method of claim 11, wherein the dynamic linking code is printed on the at least one item.

16. The method of claim 11, wherein the method further comprises:
obtaining the delivery rule of the at least one item; and
based on determining that the delivery rule indicates that the at least one item is shipped, updating the dynamic linking code to point at the second storage location of the database.

17. The method of claim 11, wherein the method further comprises:
receiving a request, from the user device, to view the status information associated with the at least one item;
obtaining the delivery rule associated with the at least one item from the first storage location of the database;
based on determining that the delivery rule indicates that the at least one item is in the manufacturing stage, displaying output information associated with the status information of the at least one item in the manufacturing stage on the user device.

18. The method of claim 11, wherein the method further comprises:
receiving a request, from the user device, to view the secondary information associated with the at least one item, wherein the request is received when the dynamic linking code is scanned by the user device;
obtaining the delivery rule associated with the at least one item from the first storage location of the database;
based on determining that the delivery rule indicates that the at least one item is shipped, displaying output information associated with the secondary information on the user device.

19. The method of claim 11, wherein the dynamic linking code comprises at least one of a quick response (QR) code or a barcode.

20. A computer programmable product comprising a non-transitory computer readable medium having stored thereon computer executable instructions which when executed by one or more processors, cause the one or more processors to validate a road object, the computer executable instructions comprising:
displaying, on a user device, information associated with at least one item from a plurality of items;
obtaining, from the user device, a selection of the at least one item by a user;
obtaining input information, from the user device, to virtually manipulate the selection of the at least one item;
generating a dynamic linking code associated with the selected at least one item, the dynamic linking code pointing to at least one of:
a first storage location of a database to store status information indicative of a status of completion of a manufacturing stage of the at least one item; and
a second storage location of the database comprising secondary information for recommending one or more other items to the user, based on the at least one item;
generating a digital image file based on the input information and the dynamic linking code, and including the dynamic linking code as a graphic within the digital image file;
transmitting the digital image file to a remote user device, wherein the remote user device is associated with at least one manufacturer of the at least one item; and
displaying, on the user device, output information associated with at least one of the status information or the secondary information, based on a delivery rule of the at least one item, the delivery rule specifying whether the at least one item has completed manufacturing and been shipped to the user.
